(19) United States
(12) Patent Application Publication
(10) Pub. No.: US 2026/0099477 A1
(43) Pub. Date: Apr. 9, 2026

(54) COLUMN DATA COMPRESSION

(71) Applicant: BEIJING OCEANBASE TECHNOLOGY CO., LTD., Hangzhou (CN)

(72) Inventors: Heng YE, Hangzhou (CN); Quanwei WAN, Hangzhou (CN)

(21) Appl. No.: 19/417,142

(22) Filed: Dec. 11, 2025

Related U.S. Application Data
(63) Continuation of application No. PCT/CN2024/111813, filed on Aug. 13, 2024.

(30) Foreign Application Priority Data
Sep. 6, 2023 (CN) 202311147786.5

(51) Int. Cl. G06F 16/22

(52) U.S. Cl. CPC G06F 16/221

(57) ABSTRACT

This specification provides a column data compression method and apparatus, and a storage medium. The method includes: separately encoding the column data in a plurality of encoding schemes at a column level, to obtain at least one data stream corresponding to each encoding scheme; determining a target encoding scheme in which smallest storage space is occupied in the plurality of encoding schemes; determining a target compression algorithm with a highest compression rate at a stream level; and compressing at least one target data stream corresponding to the target encoding scheme based on the target compression algorithm, and storing compressed target data stream in a database. In the present specification, the column data can be encoded and compressed at at least two levels: the column level and the stream level, to improve a compression rate of the column data, and save more storage space.

### TECHNICAL FIELD

One or more implementations of this specification relate to the data processing field, and in particular, to a column data compression method and apparatus, and a storage medium.

### BACKGROUND

Currently, data in a database can be stored in a column storage manner. To be specific, data in the same column in a database table can be continuously stored together. There is a higher data compression rate in comparison with a manner in which storage is performed by row. In addition, there is also higher read efficiency in a scenario in which access is performed by column.

To save storage space, column data can be compressed, but compression efficiency may be relatively low.

### SUMMARY

One or more implementations of this specification provide a column data compression method and apparatus, and a storage medium.

One or more implementations of this specification provide the following technical solutions.

According to a first aspect of one or more implementations of this specification, a column data compression method is proposed, including: separately encoding the column data in a plurality of encoding schemes at a column level, to obtain at least one data stream corresponding to each encoding scheme; determining a target encoding scheme in which smallest storage space is occupied in the plurality of encoding schemes; determining a target compression algorithm with the highest compression rate at a stream level; and compressing at least one target data stream corresponding to the target encoding scheme based on the target compression algorithm, and storing compressed target data stream in a database.

According to a second aspect of one or more implementations of this specification, a column data compression apparatus is provided, including: an encoding module, configured to separately encode the column data in a plurality of encoding schemes at a column level, to obtain at least one data stream corresponding to each encoding scheme; a first determining module, configured to determine a target encoding scheme in which smallest storage space is occupied in the plurality of encoding schemes; a second determining module, configured to determine a target compression algorithm with the highest compression rate at a stream level; and a compression module, configured to: compress at least one target data stream corresponding to the target encoding scheme based on the target compression algorithm, and store compressed target data stream in a database.

According to a third aspect of one or more implementations of this specification, an electronic device is provided, including: a processor; and a storage, configured to store processor-executable instructions. The processor runs the executable instruction, to implement the column data compression method according to any one of the above-mentioned aspects.

According to a fourth aspect of one or more implementations of this specification, a computer-readable storage medium is provided. The computer-readable storage medium stores computer instructions, and when the instructions are executed by a processor, steps of the column data compression method according to any one of the above-mentioned aspects are implemented.

The technical solutions provided in the implementations of this specification can include the following beneficial effects.

In the present specification, column data in a database table can be separately converted into a data stream in a plurality of encoding schemes at a column level, and then, at least one target data stream corresponding to a target encoding scheme in which smallest storage space is occupied is compressed based on a target compression algorithm with the highest compression rate. In the present specification, the column data can be encoded and compressed at at least two levels: the column level and the stream level, to improve a compression rate of the column data, and save more storage space.

### BRIEF DESCRIPTION OF DRAWINGS

FIG. 1 is a flowchart of a column data compression method according to an example implementation;

FIG. 2 is a block diagram of a column data compression apparatus according to an example implementation; and

FIG. 3 is a schematic structural diagram of an electronic device according to an example implementation.

### DESCRIPTION OF IMPLEMENTATIONS

Example implementations are described in detail here, and examples of the example implementations are presented in the accompanying drawings. When the following description relates to the accompanying drawings, unless specified otherwise, same numbers in different accompanying drawings represent same or similar elements. Implementations described in the following example implementations do not represent all implementations consistent with one or more implementations of this specification. On the contrary, the implementations are merely examples of apparatuses and methods that are described in the appended claims in detail and consistent with some aspects of one or more implementations of this specification.

It is worthwhile to note that, in some other implementations, the steps of the corresponding method are not necessarily performed in the order shown and described in this specification. In some other implementations, the method can include more or fewer steps than those described in this specification. In addition, a single step described in this specification may be decomposed into a plurality of steps in some other implementations for description; and a plurality of steps described in this specification may be combined into a single step for description in some other implementations.

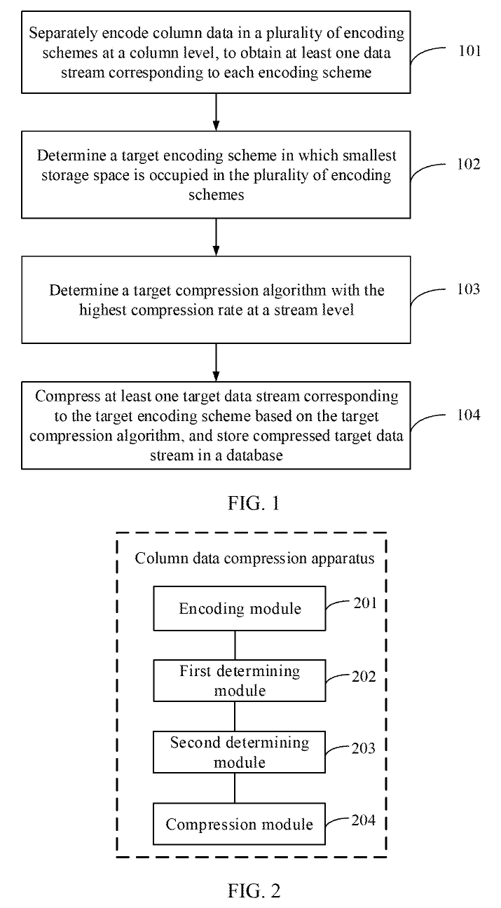

FIG. 1 is a flowchart of a column data compression method according to an example implementation. As shown in FIG. 1, the method can be performed by an electronic device. For example, the electronic device can be a server in which a database is located. The present specification sets no limitation thereto. The method includes the following steps.

Step 101: Separately encode column data based on a plurality of encoding schemes at a column level, to obtain at least one data stream corresponding to each encoding scheme.

In the present specification, an encoding scheme at a column level corresponding to the column data can be determined based on a feature, for example, a storage type, of the column data, so that data in the same column of a database table is encoded based on different encoding schemes at the column level, to obtain at least one data stream corresponding to the encoding scheme.

In an example, the storage type of the column data includes but is not limited to any one of the following: integer data, a fixed-length string, or a variable-length string.

The integer data is data that has a fixed length and that is of an integer type (for example, a uint type). The integer type can further include uint8_t, uint16_t, uint32_t, and uint64_t based on a quantity of occupied bits.

For example, uint8_t is an integer type occupying 8 bits, uint16_t is an integer type occupying 16 bits, and so on.

The fixed-length string is a string with an invariable length. For example, the length is 4 bytes.

The variable-length string is a string with a variable length. For example, a length of one string is 4 bytes, and a length of another string is 2 bytes.

In an example, the storage type of the column data is the integer data, and the column can be referred to as an integer column (IntegerColumn).

For example, the integer column can be encoded in the integer column encoding scheme, to obtain a first integer stream. The first integer stream can include each integer element in a current column of the database table.

The integer stream is a stream that continuously stores fixed-length integer data, e.g., an integer array.

In some implementations, at least one candidate integer type can be determined based on a greatest value of the integer elements in the current column. A quantity of bits occupied by the candidate integer type is greater than or equal to a quantity of bits occupied by the greatest value. A candidate integer type occupying the smallest quantity of bits is determined as an integer corresponding to the integer column encoding scheme.

For example, when an integer type corresponding to the current column is uint16_t, but the greatest value of the integer element occupies only 7 bits, the candidate integer type can be uint8_t, uint16_t, uint32_t, and uint64_t. If uint8_t occupies the smallest quantity of bits in the candidate integer type, the integer type corresponding to the integer column encoding scheme is uint8_t.

For example, the integer column can be encoded in a dictionary column encoding scheme, to obtain a second integer stream and a first index stream. The second integer stream can include each integer element in the current column of the database table.

The second integer stream can include integer elements that are different from each other in the current column. For example, the second integer stream includes an array including a unique value of the current column.

For example, the current column includes the following integer elements in an ascending order of row numbers: an integer element #1, the integer element #1, an integer element #5, an integer element #3, an integer element #4, the integer element #5, ..., and the second integer stream can include the integer element #1, the integer element #5, the integer element #3, and the integer element #4.

It can be understood that the same integer column encoding scheme can be used for the second integer stream and the first integer stream, and the integer type corresponding to the integer column encoding scheme is the candidate integer type occupying the smallest quantity of bits.

The first index stream can be a ref array, and is used to record a row number of each row of data in the second integer stream. For example, the first index stream can be used to query the second integer stream.

For example, the first index stream includes: {0, 1}, {2, 5}, {3}, {4}, ....

In the present specification, data in the current column can be encoded in the dictionary column encoding scheme when a quantity of unique values included in the current column is less than or equal to a preset threshold.

In an example, the storage type of the column data is a string, and each string has an invariable length, that is, is a fixed-length string. The column can be referred to as a string column (StringColumn).

For example, the string column can be encoded in the string column encoding scheme, to obtain a first string stream. The first string stream can include each string in the current column of the database table.

The string stream is a string array for continuously storage, and includes only specific content of a string, but does not include string length information.

In this implementation of the present specification, because each string has an invariable length, only the first string stream can be obtained after the string column is encoded in the string column encoding scheme.

For example, the string column can be encoded in the dictionary column encoding scheme, to obtain a second string stream and a second index stream.

The second string stream can include strings that are different from each other in the current column of the database table. For example, the second string stream includes the unique value of the current column.

For example, the current column includes the following strings in ascending order of row numbers: a string #1, a string #3, a string #2, the string #2, a string #4, a string #5, ..., and the second string stream can include the string #1, the string #3, the string #2, the string #4, the string #5, ....

It can be understood that the second string stream can be encoded in the same string column encoding scheme as the first string stream.

The second index stream can be a ref array, and is used to record a row number of each row of data in the second string stream. That is, the second index stream can be used to query the second string stream.

For example, the second index stream includes: {0}, {1}, {2, 3}, {4}, {5}, ....

In an example, the storage type of the column data is a string, and each string has a variable length, that is, is a variable-length string. The column can also be referred to as a string column (StringColumn).

For example, the string column can be encoded in a string column encoding scheme, to obtain a third string stream and a third integer stream. The third string stream can include each string in the current column of the database table. The third integer stream is used to determine a length of each string in the third string stream.

The string stream is a string array for continuously storage, and includes only specific content of a string, but does not include string length information.

In this implementation of the present specification, because each string has a variable length, after the string column is encoded in the string column encoding scheme, the third string stream and the third integer stream are obtained.

In some implementations, the third integer stream can store an offset of an end position of each row of strings in the third string stream, and a difference between two adjacent offsets is a length of a current row of strings.

For example, the string column can be encoded in the dictionary column encoding scheme, to obtain a fourth string stream, a fourth integer stream, and a third index stream. The fourth string stream includes strings that are different from each other in the current column, the fourth integer stream is used to determine a length of each string in the fourth string stream, and the third index stream is used to query the fourth string stream. The third index stream can also be a ref array.

Because the string length has a variable length, after encoding in the dictionary column encoding scheme, three streams are obtained, and are a fourth string stream used to record unique values (strings that are different from each other) in the current column, a fourth integer stream used to record a length of each string in the fourth string stream, and a third index stream used to query the fourth string stream.

The above-mentioned descriptions are merely example descriptions. An encoding scheme of the column data at the column level is not limited in the present specification.

Step 102: Determine a target encoding scheme in which smallest storage space is occupied in the plurality of encoding schemes.

In the present specification, storage space occupied by original stream data can be determined based on the original stream data. Storage space occupied by the integer stream can be determined based on a size of integer array space, and storage space occupied by a string stream can be determined based on a total length of a string. For the sum of storage space occupied by at least one data stream corresponding to the same encoding scheme, a size of storage space occupied by the data stream corresponding to the encoding scheme is obtained.

For example, the storage type corresponding to the column data is integer data, and the first integer stream is obtained in the integer column encoding scheme. The second integer stream and the first index stream are obtained in the dictionary column encoding scheme. A size of storage space occupied by the first integer stream is a first byte quantity, and a size of storage space occupied by the second integer stream and the first index stream is a second byte quantity. If the first byte quantity is less than the second byte quantity, the target encoding scheme is the integer column encoding scheme; or if the first byte quantity is greater than the second byte quantity, the target encoding scheme is the dictionary column encoding scheme.

For another example, the storage type corresponding to the column data is a string, and each string has an invariable length. The first string stream is obtained in the string column encoding scheme. The second string stream and the second index stream are obtained in the dictionary column encoding scheme. A size of storage space occupied by the first string stream is a third byte quantity, and a size of storage space occupied by the second string stream and the second index stream is a fourth byte quantity. If the third byte quantity is less than the fourth byte quantity, the target encoding scheme is the string column encoding scheme; or if the third byte quantity is greater than the fourth byte quantity, the target encoding scheme is the dictionary column encoding scheme.

For another example, the storage type corresponding to the column data is a string, and each string has a variable length. The third string stream and the third integer stream are obtained in the string column encoding scheme. The fourth character stream, the fourth integer stream, and the third index stream are obtained in the dictionary column encoding scheme. A size of storage space occupied by the third character stream and the third integer stream is a fifth byte quantity, and a size of storage space occupied by the fourth character stream, the fourth integer stream, and the third index stream is a sixth byte quantity. If the fifth byte quantity is less than the sixth byte quantity, the target encoding scheme is the string column encoding scheme; or if the fifth byte quantity is greater than the sixth byte quantity, the target encoding scheme is the dictionary column encoding scheme.

Step 103: Determine a target compression algorithm with the highest compression rate at a stream level.

In the present specification, a data stream obtained through column level encoding can be an integer stream or a string stream.

Candidate compression algorithm sets respectively corresponding to the integer stream and the string stream can be preset on the electronic device.

In an example, a candidate compression algorithm set corresponding to the integer stream can include but is not limited to at least one of the following: a Pfor (Pfor) compression algorithm, a run length encoding (RLE) compression algorithm, a Huffman (ZigZag) compression algorithm, a delta compression algorithm, or a double delta compression algorithm.

In an example, a candidate compression algorithm set corresponding to the string stream can include but is not limited to at least one of the following: a prefix compression algorithm or a general compression algorithm.

The general compression algorithm includes but is not limited to a zip compression algorithm, a Lempel–Ziv–Welch (LZW) compression algorithm, an LZ77 or LZ78 (also known as Lempel-Ziv 1 “LZ1” or Lempel-Ziv 2 “LZ2”, respectively) based compression algorithm, etc.

In the present specification, a corresponding candidate compression algorithm can be selected based on a feature of the data stream, at least a part of data included in at least one target data stream is separately compressed based on each candidate compression algorithm, to obtain compressed data, and then a candidate compression algorithm with the smallest quantity of bits occupied by the compressed data is determined as the target compression algorithm.

For example, all data included in the target data stream can be separately compressed based on different candidate compression algorithms, and then a candidate compression algorithm in which compressed data occupies the smallest quantity of bits is determined as the target compression algorithm.

It is considered that it takes a large amount of time to compress all data included in the target data stream. In the present specification, the data included in the at least one target data stream can be sampled based on a preset sampling rate, to obtain sampled data. Further, the sampled data can be separately compressed based on each candidate compression algorithm, to obtain compressed data. Further, the candidate compression algorithm in which compressed data occupies the smallest quantity of bits is determined as the target compression algorithm. Therefore, a delay of determining the target compression algorithm is reduced.

The sampling rate can be any value in an interval (0, 1). For example, the sampling rate can be any value greater than 0 and less than 1. For example, the sampling rate can be 0.25 (25%).

Step 104: Compress at least one target data stream corresponding to the target encoding scheme based on the target compression algorithm, and store compressed target data stream in a database.

In the present specification, a data stream corresponding to the target encoding scheme is a target data stream, and there can be one or more target data streams.

For example, the target encoding scheme is an integer column encoding scheme, the target data stream is a first integer stream, and there is one target data stream.

For another example, the target encoding scheme is a dictionary column encoding scheme, the target data stream includes a second integer stream and a first index stream scheme, and there are two target data streams.

For another example, the target encoding scheme is the string column encoding scheme, the target data stream includes a first string stream, and there is one target data stream.

For another example, the target encoding scheme is the dictionary column encoding scheme, the target data stream includes a second string stream and a second index stream, and there are two target data streams.

For another example, the target encoding scheme is the string column encoding scheme, the target data stream includes a third string stream and a third integer stream, and there are two target data streams.

For another example, the target encoding scheme is the dictionary column encoding scheme, the target data stream includes a fourth character series stream, a fourth integer stream, and a third index stream, and there are three target data streams.

In the present specification, after the target compression algorithm is determined, all data of the target data stream can be compressed based on the target compression algorithm, and the compressed target data stream is stored in the database.

For example, the compressed target data stream can be stored in a storage medium of the database.

For example, the compressed target data stream can alternatively be stored in other hardware or software, or an associated storage medium of the database. The present specification sets no limitation thereto.

When the database table needs to be queried, compressed target data stream corresponding to a field that needs to be queried, namely, a field to which the column data belongs, can be found from the storage medium of the database based on the field. Further, target data streams can be obtained through decompression based on the target compression algorithm. Further, an integer element or string is found from the target data stream. A search result is returned.

In the above-mentioned implementation, the column data is effectively encoded and compressed by fully considering a feature of data at at least two layers (the column level and the stream level) in a hierarchical encoding scheme, to improve a compression rate, save more storage space, and improve availability.

In some implementations, to better process an online analytical processing (OLAP) service in the database, data in the same column in the database table is continuously stored together in a column storage manner, and data in the same column can be better encoded and compressed due to the same data type.

To save storage space, relatively high data encoding/decoding performance needs to be ensured when column storage is performed. Therefore, the present specification provides the above-mentioned column data compression method.

First, the column data is encoded in different encoding schemes at the column level, to obtain at least one data stream corresponding to each encoding scheme. The candidate compression algorithm with the highest compression rate is selected from the candidate compression algorithm based on a feature of each data stream, to perform compression. A process of encoding the column data to obtain the data stream can be referred to as column level encoding, and a process of compressing the data stream can be referred to as stream level encoding.

In comparison with a case in which the column data is directly compressed based on a common algorithm, in the present specification, data is encoded and compressed at at least two levels by repeatedly considering the feature of the data, to implement a higher compression rate.

In addition, in the present specification, a data length obtained based on each candidate compression algorithm can be precisely calculated, so that the target compression algorithm with the highest compression rate can be selected to compress the stream data, the compression rate is also improved, and a size of occupied storage space can be reduced. In this way, availability is high.

As shown in FIG. 2, a column data compression apparatus can be applied to an electronic device, for example, a server in which a database is located, to implement the technical solutions of this specification. The column data compression apparatus can include: an encoding module 201, configured to separately encode the column data in a plurality of encoding schemes at a column level, to obtain at least one data stream corresponding to each encoding scheme; a first determining module 202, configured to determine a target encoding scheme in which smallest storage space is occupied in the plurality of encoding schemes; a second determining module 203, configured to determine a target compression algorithm with the highest compression rate at a stream level; and a compression module 204, configured to: compress at least one target data stream corresponding to the target encoding scheme based on the target compression algorithm, and store compressed target data stream in a database.

The system, apparatus, module, or unit illustrated in the above-mentioned implementations can be implemented by using a computer chip or an entity, or can be implemented by using a product having a certain function. A typical implementation device is a computer, and an example form of the computer may be a personal computer, a laptop computer, a cellular phone, a camera phone, a smartphone, a personal digital assistant, a media player, a navigation device, an e-mail transceiver device, a game console, a tablet computer, a wearable device, or any combination of several devices in these devices.

In a typical configuration, the computer includes one or more processors (CPUs), one or more input/output interfaces, one or more network interfaces, and one or more memories (or memory devices). The one or more processors may be configured to individually or collectively conduct actions to implement the methods provided herein. When the one or more processors collectively conduct actions, they may or may not conduct the same action or same part of an action at a same time and they may conduct different actions or different parts of an action collectively.

The memory may include at least one of a non-persistent memory, a random access memory (RAM), and a nonvolatile memory in a computer-readable medium, for example, a read-only memory (ROM) or a flash read-only memory (flash RAM). The memory is an example of the computer-readable medium. The one or more memory devices (memories) may be configured to individually or collectively store computer executable instructions to enable the methods provided herein. When the one or more memory devices collectively store computer executable instructions, they may or may not store the same instruction or same part of an instruction at a same time and they may store different instructions or different parts of an instruction collectively.

The computer-readable medium includes a persistent and a non-persistent, removable and non-removable media, which implement information storage by using any method or technology. The information may be a computer-readable instruction, a data structure, a program module, or other data. Examples of a computer storage medium include but are not limited to a phase change random access memory (PRAM), a static RAM (SRAM), a dynamic RAM (DRAM), a RAM of another type, a read-only memory (ROM), an electrically erasable programmable ROM (EEPROM), a flash memory or another memory technology, a compact disc ROM (CD-ROM), a digital versatile disc (DVD) or another optical storage, a cassette tape, a magnetic disk storage, a quantum memory, a storage medium based on graphene, another magnetic storage device, or any other non-transmission medium. The computer storage medium can be configured to store information that can be accessed by the computing device. Based on the definition in this specification, the computer-readable medium does not include transitory media such as a modulated data signal and carrier.

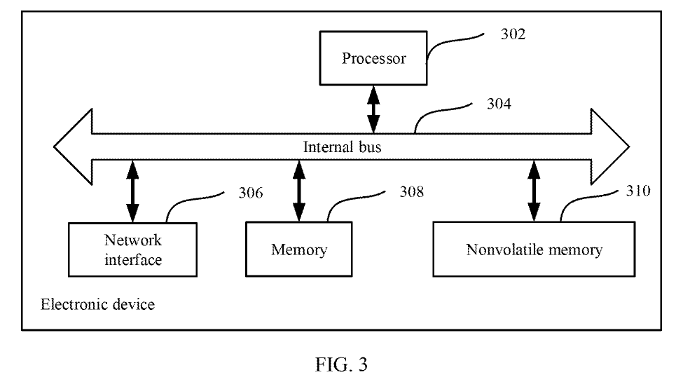

FIG. 3 is a schematic structural diagram of an electronic device according to an example implementation. As shown in FIG. 3, at a hardware level, the device includes a processor 302, an internal bus 304, a network interface 306, a memory 308, and a nonvolatile memory 310, and certainly may further include other hardware needed by a service. One or more implementations of this specification can be implemented based on software. For example, the processor 302 reads a corresponding computer program from the nonvolatile memory 310 to the memory 308 and then runs the computer program. Certainly, in addition to software implementations, one or more implementations of this specification do not preclude other implementations, such as a logic device or a combination of software and hardware. For example, an execution body of the following processing procedure is not limited to each logical unit, and can be hardware or a logic device.

It is worthwhile to further note that, the terms "include", "comprise", or any other variant thereof are intended to cover a non-exclusive inclusion, so that a process, a method, a product, or a device that includes a list of elements not only includes those elements but also includes other elements which are not expressly listed, or further includes elements inherent to such process, method, product, or device. Without more constraints, an element preceded by "includes a …" does not preclude the existence of additional identical elements in the process, method, product, or device that includes the element.

Example implementations of this specification are described above. Other implementations fall within the scope of the appended claims. In some cases, the actions or steps described in the claims can be performed in an order different from that in the implementations, and the desired results can still be achieved. In addition, the process depicted in the accompanying drawings does not necessarily need a particular order or consecutive order to achieve the desired results. In some implementations, multi-tasking and parallel processing are feasible or may be advantageous.

Terms used in one or more implementations of this specification are merely used to describe example implementations, and are not intended to limit the one or more implementations of this specification. The terms "a" and "the" of singular forms used in one or more implementations of this specification and the appended claims are also intended to include plural forms, unless otherwise specified in the context clearly. It should be further understood that the term "and/or" used in this specification indicates and includes any or all possible combinations of one or more associated listed items.

It should be understood that although terms "first", "second", "third", etc. may be used in one or more implementations of this specification to describe various types of information, the information should not be limited to these terms. These terms are used merely to differentiate information of the same type. For example, without departing from the scope of one or more implementations of this specification, first information can also be referred to as second information, and similarly, the second information can also be referred to as the first information. Depending on the context, for example, the word "if" used here can be explained as "while", "when", or "in response to determining".

The above-mentioned descriptions are merely example implementations of one or more implementations of this specification, but are not intended to limit the one or more implementations of this specification. Any modification, equivalent replacement, improvement, etc. made without departing from the spirit and principle of the one or more implementations of this specification shall fall within the protection scope of the one or more implementations of this specification.

What is claimed is:

1. A column data compression method, comprising:
separately encoding column data based on a plurality of encoding schemes at a column level, to obtain at least one data stream corresponding to each encoding scheme of the plurality of encoding schemes;
determining a target encoding scheme that occupies a smallest storage space among the plurality of encoding schemes;
determining a target compression algorithm with a highest compression rate at a stream level; and
compressing the at least one target data stream corresponding to the target encoding scheme based on the target compression algorithm.

2. The method according to claim 1, wherein a storage type of the column data is integer data, and the separately encoding the column data based on a plurality of encoding schemes at a column level, to obtain at least one data stream corresponding to each encoding scheme comprises:
encoding the column data in an integer column encoding scheme, to obtain a first integer stream, wherein the first integer stream includes each integer element in a current column; and
encoding the column data in a dictionary column encoding scheme, to obtain a second integer stream and a first index stream, wherein the second integer stream includes integer elements that are different from one another in a current column, and the first index stream is configured to query the second integer stream.

3. The method according to claim 2, further comprising:
determining at least one candidate integer type based on a greatest value of the integer elements in the current column, wherein a storage space occupied by each candidate integer type of the at least one candidate integer type is greater than or equal to a storage space occupied by the greatest value; and
determining a candidate integer type that occupies a smallest storage space among the at least one candidate integer type as an integer type corresponding to the integer column encoding scheme.

4. The method according to claim 1, wherein a storage type of the column data is a string, each string has an invariable length, and the separately encoding the column data based on a plurality of encoding schemes at a column level, to obtain at least one data stream corresponding to each encoding scheme comprises:
encoding the column data in a string column encoding scheme, to obtain a first string stream, wherein the first string stream includes each string in a current column; and
encoding the column data in a dictionary column encoding scheme, to obtain a second string stream and a second index stream, wherein the second string stream includes strings that are different from one another in the current column, and the second index stream is configured to query the second string stream.

5. The method according to claim 1, wherein a storage type of the column data is a string, each string has a variable length, and the separately encoding the column data based on a plurality of encoding schemes at a column level, to obtain at least one data stream corresponding to each encoding scheme comprises:
encoding the column data in a string column encoding scheme, to obtain a third string stream and a third integer stream, wherein the third string stream includes each string in a current column, and the third integer stream is configured to determine a length of each string in the third string stream; and
encoding the column data in a dictionary column encoding scheme, to obtain a fourth string stream, a fourth integer stream, and a third index stream, wherein the fourth string stream includes strings that are different from one another in the current column, the fourth integer stream is configured to determine a length of each string in the fourth string stream, and the third index stream is configured to query the fourth string stream.

6. The method according to claim 1, wherein the determining a target compression algorithm with a highest compression rate at a stream level comprises:
separately compressing, based on each of at least one candidate compression algorithm, at least a part of data included in the at least one target data stream, to obtain compressed data; and
determining a candidate compression algorithm corresponding to compressed data that occupies smallest storage space among the at least one candidate compression algorithm as the target compression algorithm.

7. The method according to claim 6, further comprising:
sampling, based on a sampling rate, data in the at least one target data stream, to obtain sampled data,
wherein the separately compressing, based on each of at least one candidate compression algorithm, at least a part of data included in the at least one target data stream, to obtain compressed data comprises:
separately compressing the sampled data based on each candidate compression algorithm, to obtain the compressed data.

8. An electronic system, comprising:
one or more processors; and
one or more storage devices, individually or collectively, having computer executable instructions stored thereon, the computer executable instructions, when executed by the one or more processors, enabling the one or more processors, individually or collectively, to implement actions including:
separately encoding column data based on a plurality of encoding schemes at a column level, to obtain at least one data stream corresponding to each encoding scheme of the plurality of encoding schemes;
determining a target encoding scheme that occupies a smallest storage space among the plurality of encoding schemes;
determining a target compression algorithm with a highest compression rate at a stream level; and
compressing the at least one target data stream corresponding to the target encoding scheme based on the target compression algorithm.

9. The electronic system according to claim 8, wherein a storage type of the column data is integer data, and the separately encoding the column data based on a plurality of encoding schemes at a column level, to obtain at least one data stream corresponding to each encoding scheme comprises:
encoding the column data in an integer column encoding scheme, to obtain a first integer stream, wherein the first integer stream includes each integer element in a current column; and
encoding the column data in a dictionary column encoding scheme, to obtain a second integer stream and a first index stream, wherein the second integer stream includes integer elements that are different from one another in a current column, and the first index stream is configured to query the second integer stream.

10. The electronic system according to claim 9, wherein the actions further include:
determining at least one candidate integer type based on a greatest value of the integer elements in the current column, wherein a storage space occupied by each candidate integer type of the at least one candidate integer type is greater than or equal to a storage space occupied by the greatest value; and
determining a candidate integer type that occupies a smallest storage space among the at least one candidate integer type as an integer type corresponding to the integer column encoding scheme.

11. The electronic system according to claim 8, wherein a storage type of the column data is a string, each string has an invariable length, and the separately encoding the column data based on a plurality of encoding schemes at a column level, to obtain at least one data stream corresponding to each encoding scheme comprises:
encoding the column data in a string column encoding scheme, to obtain a first string stream, wherein the first string stream includes each string in a current column; and
encoding the column data in a dictionary column encoding scheme, to obtain a second string stream and a second index stream, wherein the second string stream includes strings that are different from one another in the current column, and the second index stream is configured to query the second string stream.

12. The electronic system according to claim 8, wherein a storage type of the column data is a string, each string has a variable length, and the separately encoding the column data based on a plurality of encoding schemes at a column level, to obtain at least one data stream corresponding to each encoding scheme comprises:
encoding the column data in a string column encoding scheme, to obtain a third string stream and a third integer stream, wherein the third string stream includes each string in a current column, and the third integer stream is configured to determine a length of each string in the third string stream; and
encoding the column data in a dictionary column encoding scheme, to obtain a fourth string stream, a fourth integer stream, and a third index stream, wherein the fourth string stream includes strings that are different from one another in the current column, the fourth integer stream is configured to determine a length of each string in the fourth string stream, and the third index stream is configured to query the fourth string stream.

13. The electronic system according to claim 8, wherein the determining a target compression algorithm with a highest compression rate at a stream level comprises:
separately compressing, based on each of at least one candidate compression algorithm, at least a part of data included in the at least one target data stream, to obtain compressed data; and
determining a candidate compression algorithm corresponding to compressed data that occupies smallest storage space among the at least one candidate compression algorithm as the target compression algorithm.

14. The electronic system according to claim 13, wherein the actions further include:
sampling, based on a sampling rate, data in the at least one target data stream, to obtain sampled data,
wherein the separately compressing, based on each of at least one candidate compression algorithm, at least a part of data included in the at least one target data stream, to obtain compressed data comprises:
separately compressing the sampled data based on each candidate compression algorithm, to obtain the compressed data.

15. A computer-readable storage medium, having computer executable instructions stored thereon, the computer executable instructions, when executed by one or more processors, enabling the one or more processors to, individually or collectively, implement actions comprising:
separately encoding column data based on a plurality of encoding schemes at a column level, to obtain at least one data stream corresponding to each encoding scheme of the plurality of encoding schemes;
determining a target encoding scheme that occupies a smallest storage space among the plurality of encoding schemes;
determining a target compression algorithm with a highest compression rate at a stream level; and
compressing the at least one target data stream corresponding to the target encoding scheme based on the target compression algorithm.

16. The computer-readable storage medium according to claim 15, wherein a storage type of the column data is integer data, and the separately encoding the column data based on a plurality of encoding schemes at a column level, to obtain at least one data stream corresponding to each encoding scheme comprises:
encoding the column data in an integer column encoding scheme, to obtain a first integer stream, wherein the first integer stream includes each integer element in a current column; and
encoding the column data in a dictionary column encoding scheme, to obtain a second integer stream and a first index stream, wherein the second integer stream includes integer elements that are different from one another in a current column, and the first index stream is configured to query the second integer stream.

17. The computer-readable storage medium according to claim 16, wherein the actions further include:
determining at least one candidate integer type based on a greatest value of the integer elements in the current column, wherein a storage space occupied by each candidate integer type of the at least one candidate integer type is greater than or equal to a storage space occupied by the greatest value; and
determining a candidate integer type that occupies a smallest storage space among the at least one candidate integer type as an integer type corresponding to the integer column encoding scheme.

18. The computer-readable storage medium according to claim 15, wherein a storage type of the column data is a string, each string has an invariable length, and the separately encoding the column data based on a plurality of encoding schemes at a column level, to obtain at least one data stream corresponding to each encoding scheme comprises:
encoding the column data in a string column encoding scheme, to obtain a first string stream, wherein the first string stream includes each string in a current column; and
encoding the column data in a dictionary column encoding scheme, to obtain a second string stream and a second index stream, wherein the second string stream includes strings that are different from one another in the current column, and the second index stream is configured to query the second string stream.

19. The computer-readable storage medium according to claim 15, wherein a storage type of the column data is a string, each string has a variable length, and the separately encoding the column data based on a plurality of encoding schemes at a column level, to obtain at least one data stream corresponding to each encoding scheme comprises:
encoding the column data in a string column encoding scheme, to obtain a third string stream and a third integer stream, wherein the third string stream includes each string in a current column, and the third integer stream is configured to determine a length of each string in the third string stream; and
encoding the column data in a dictionary column encoding scheme, to obtain a fourth string stream, a fourth integer stream, and a third index stream, wherein the fourth string stream includes strings that are different from one another in the current column, the fourth integer stream is configured to determine a length of each string in the fourth string stream, and the third index stream is configured to query the fourth string stream.

20. The computer-readable storage medium according to claim 15, wherein the determining a target compression algorithm with a highest compression rate at a stream level comprises:
separately compressing, based on each of at least one candidate compression algorithm, at least a part of data included in the at least one target data stream, to obtain compressed data; and
determining a candidate compression algorithm corresponding to compressed data that occupies smallest storage space among the at least one candidate compression algorithm as the target compression algorithm.
